(19) United States
(12) Patent Application Publication
(10) Pub. No.: US 2018/0190993 A1
(43) Pub. Date: Jul. 5, 2018

(54) ELECTRODE AND METAL-AIR SECONDARY BATTERY

(71) Applicant: HITACHI ZOSEN CORPORATION, Osaka (JP)

(72) Inventors: Sousuke NISHIURA, Osaka (JP); Masanobu AIZAWA, Osaka (JP); Takehiro SHIMIZU, Osaka (JP); Kazuya KAMEYAMA, Osaka (JP)

(21) Appl. No.: 15/739,356

(22) PCT Filed: Jun. 20, 2016
(86) PCT No.: PCT/JP2016/068294

§ 371 Date: Dec. 22, 2017

(30) Foreign Application Priority Data
Jul. 1, 2015 (JP) 2015-132873

(51) Int. Cl. H01M 4/86; H01M 4/90; H01M 12/08

(52) U.S. Cl. CPC H01M 4/8652; H01M 2004/8689; H01M 12/08; H01M 4/9033

(57) ABSTRACT

A positive electrode of a metal-air secondary battery includes a conductive layer having electrical conductivity, and a catalyst layer laminated on the conductive layer. Particles of different types of perovskite oxides, namely a first perovskite-type oxide and a second perovskite-type oxide, are dispersed in the catalyst layer. The first perovskite-type oxide has an average particle diameter greater than or equal to 2 micrometers and less than or equal to 9 micrometers, and the second perovskite-type oxide has an average particle diameter greater than or equal to 0.10 micrometers and less than or equal to 1.0 micrometers. This composition improves battery performance while maintaining a certain level of strength of the catalyst layer.

### TECHNICAL FIELD

The present invention relates to an electrode and a metal-air secondary battery.

### BACKGROUND ART

There are conventionally known metal-air batteries that use a metal as an active material for the negative electrode and oxygen from the air as an active material for the positive electrode. As a catalyst used in the positive electrode, various materials are being considered. For example, Japanese Patent Application Laid-Open Nos. 2005-190833 and 2014-194898 propose catalyst layers in which particles of two types of perovskite-type oxides are dispersed. A technique for accelerating surface reactions on the cathode by introducing heterointerfaces into a solid oxide fuel cell is disclosed in “Composite Cathode of Perovskite-Related Oxides, (La, Sr)CoO_{3-δ}/(La, Sr)₂CoO_{4-δ}, for Solid Oxide Fuel Cells” by Keiji Yashiro, et. al., Electrochemical and Solid-State Letters, 2009, 12(9), B135-B137.

In the case where particles of two types of perovskite-type oxides are dispersed in a catalyst layer, the strength of the catalyst layer may decrease, or the performance of batteries using such an electrode may degrade, depending on the sizes of the particles.

### SUMMARY OF INVENTION

The present invention is intended for an electrode for use in a metal-air secondary battery, and it is an object of the present invention to improve battery performance while maintaining a certain level of strength of a catalyst layer.

An electrode according to the present invention includes a conductive layer having electrical conductivity, and a catalyst layer laminated on the conductive layer. Particles of a first perovskite-type oxide and particles of a second perovskite-type oxide are dispersed in the catalyst layer, the first perovskite-type oxide and the second perovskite-type oxide being of different types. The first perovskite-type oxide has an average particle diameter greater than or equal to 2 micrometers and less than or equal to 9 micrometers, and the second perovskite-type oxide has an average particle diameter greater than or equal to 0.10 micrometers and less than or equal to 1.0 micrometers.

According to the present invention, it is possible to improve battery performance while maintaining a certain level of strength of the catalyst layer.

In a preferred embodiment of the present invention, a volume of the first perovskite-type oxide contained in the catalyst layer is 0.25 times or more and 4 times or less a volume of the second perovskite-type oxide.

In this case, preferably, the volume of the first perovskite-type oxide contained in the catalyst layer is approximately equal to the volume of the second perovskite-type oxide. The first perovskite-type oxide has an average particle diameter less than or equal to 4 micrometers, and the second perovskite-type oxide has an average particle diameter less than or equal to 0.5 micrometers.

In another preferred embodiment of the present invention, one of the first perovskite-type oxide and the second perovskite-type oxide is LaSrMnFeO₃, and the other of the first perovskite-type oxide and the second perovskite-type oxide is LaSrCoFeO₃.

The present invention is also intended for a metal-air secondary battery. The metal-air secondary battery according to the present invention includes a positive electrode that is the electrode described above, a negative electrode, and an electrolyte layer disposed between the negative electrode and the positive electrode.

Preferably, the positive electrode and the electrolyte layer each are disposed in a tubular shape about the negative electrode.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 illustrates a configuration of a metal-air battery;

FIG. 2 illustrates a photograph of a positive electrode catalyst layer taken with an electron microscope; and

FIG. 3 illustrates evaluation results for samples.

### DESCRIPTION OF EMBODIMENTS

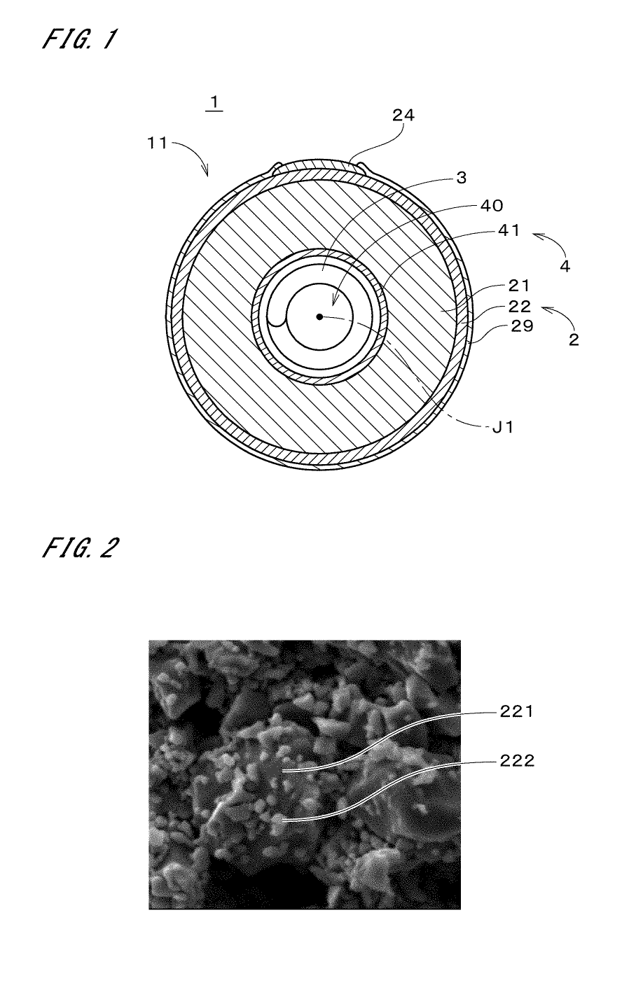

FIG. 1 illustrates a configuration of a metal-air battery 1 according to an embodiment of the present invention. The metal-air battery 1 in FIG. 1 is a secondary battery using zinc ions, i.e., a zinc-air secondary battery. The metal-air battery may use other metal ions. A main body 11 of the metal-air battery 1 has a generally columnar shape centered on a central axis J1, and FIG. 1 illustrates a cross-section of the main body 11 (excluding a negative electrode 3, which will be described later) taken in a plane perpendicular to the central axis J1. The metal-air battery 1 includes a positive electrode 2, the negative electrode 3, and an electrolyte layer 4.

The negative electrode 3 (also referred to as a “metal electrode”) is a coiled member centered on the central axis J1. The negative electrode 3 according to the present embodiment is shaped by winding a linear member having a generally circular cross-sectional shape in a spiral about the central axis J1. The negative electrode 3 includes a coiled base member formed of a conductive material, and a deposited metal layer formed on a surface of the base member. The ends of the negative electrode 3 in the direction of the central axis J1 are connected to a negative electrode current collecting terminal (not shown).

Examples of the material for the above base member include metals such as copper (Cu), nickel (Ni), silver (Ag), gold (Au), iron (Fe), aluminum (Al), and magnesium (Mg), and alloys that contain any of these metals. In the present embodiment, the base member is made of copper. From the viewpoint of increasing the electrical conductivity of the base member that serves also as a current collector, it is preferable for the base member to contain copper or a copper alloy. When the main body of the base member is made of copper, it is preferable that a protective film made of other metals such as nickel be formed on a surface of the main body. In this case, the surface of the base member is equivalent to the surface of the protective film. For example, the protective film has a thickness of 1 to 20 micrometers (μm) and is formed by plating. The deposited metal layer is formed by electrodeposition of zinc (Zn). Alternatively, the deposited metal layer may be formed by electrodeposition of an alloy that contains zinc. Depending on the design of the metal-air battery 1, the negative electrode 3 may have a tubular or rod-like shape.

A cylindrical separator 41 is provided on the periphery of the negative electrode 3, and the cylindrical positive electrode 2 (also referred to as an “air electrode”) is provided on the periphery of the separator 41. That is, the inner side surface of the separator 41 opposes the negative electrode 3, and the outer side surface of the separator 41 opposes the inner side surface of the positive electrode 2. The negative electrode 3, the separator 41, and the positive electrode 2 are provided concentrically about the central axis J1, and the distance between the outer edge of the negative electrode 3 and the positive electrode 2, when viewed along the central axis J1, is constant over the entire circumference in a circumferential direction about the central axis J1. That is, the interval between equipotential surfaces of the negative electrode 3 and the positive electrode 2 in the metal-air battery 1 is constant over the entire circumference. Since the equipotential surfaces have no unevenness, current distribution during charge and discharge is constant in the circumferential direction. Note that the positive electrode 2 may have other shapes such as a regular polygonal tubular shape having six or more vertices, as long as the current distribution is approximately uniform over the entire circumference.

The positive electrode 2 includes a porous positive electrode conductive layer 21 that is a tubular support made of conductive ceramic, and a positive electrode catalyst layer 22 that is laminated on the outer side surface of the positive electrode conductive layer 21 on the side opposite to the negative electrode 3. Preferably, the positive electrode catalyst layer 22 is formed over the entire circumference of the positive electrode conductive layer 21. An interconnector 24 made of ceramic having alkali resistance is provided on part of the outer side surface of the positive electrode catalyst layer 22. The interconnector 24 has a thickness of, for example, approximately 30 to 300 μm. The interconnector 24 is connected to a positive electrode current collecting terminal (not shown). On the area of the outer side surface of the positive electrode catalyst layer 22 that is not covered with the interconnector 24, a porous layer made of a material having water repellent properties (e.g., tetrafluoroethylene-hexafluoropropylene copolymer (FEP) or polytetrafluoroethylene (PTFE)) is formed as a liquid repellent layer 29. The liquid repellent layer 29 has high gas permeability and high liquid impermeability.

The positive electrode conductive layer 21 is formed by extrusion molding and firing of a material that contains conductive ceramic, and has electrical conductivity. Preferable examples of the conductive ceramic include perovskite-type oxides and spinel-type oxides, both having electrical conductivity. In the present embodiment, the positive electrode conductive layer 21 is made of a perovskite-type oxide (e.g., LaSrMnO₃ (LSM), LaSrMnFeO₃ (LSMF), or LaSrCoFeO₃ (LSCF)). It is preferable for the perovskite-type oxide used for the positive electrode conductive layer 21 to contain at least one kind of Co, Mn, and Fe. From the viewpoint of preventing degradation due to oxidation during charge, it is preferable for the positive electrode conductive layer 21 to contain no conductive carbon. The positive electrode conductive layer 21 may also be formed of other conductive ceramic.

The positive electrode catalyst layer 22 is a porous film formed on the outer side surface of the positive electrode conductive layer 21, and is supported by the positive electrode conductive layer 21 serving as a support. The positive electrode catalyst layer 22 contains a positive electrode catalyst, and is formed on the positive electrode conductive layer 21 by, for example, a slurry coating method and firing. Preferably, the thickness of the positive electrode catalyst layer 22 is smaller enough than the thickness of the positive electrode conductive layer 21. In the metal-air battery 1, in principle, an interface between air and an electrolytic solution 40, which will be described later, is formed in the vicinity of the porous positive electrode catalyst layer 22. The details of the positive electrode catalyst layer 22 will be described later.

The separator 41 already described is a porous film that is formed on the inner side surface of the positive electrode conductive layer 21 on the same side as the negative electrode 3, and is formed over the entire circumference on this inner side surface. The separator 41 is, for example, a sintered compact of ceramic powder having high mechanical strength and high insulating properties, such as silica (SiO₂), alumina (Al₂O₃), zirconia (ZrO₂), titania (TiO₂), hafnia (HfO₂), or ceria (CeO₂), and has alkali resistance. As will be described later, the preparation of the separator 41 involves depositing slurry that contains the aforementioned ceramic powder and a binder on the inner side surface of the positive electrode conductive layer 21 by, for example, a slurry coating method, drying the slurry, and removing the binder contained in the slurry by firing at a high temperature. The removal of the binder prevents the lifetime of the separator from being reduced due to degradation of the binder. The separator 41 is preferably made of only ceramic. Alternatively, the separator 41 may be a mixture or laminated body of the aforementioned ceramics.

The inner space of the tubular positive electrode 2 (on the same side as the central axis J1) is filled with the aqueous electrolytic solution 40. The electrolytic solution 40 exists between and in contact with the positive electrode 2 and the negative electrode 3. The negative electrode 3 is immersed in almost its entirety in the electrolytic solution 40. The porous separator 41 and the pores in the positive electrode conductive layer 21 are also filled with the electrolytic solution 40. Some pores in the positive electrode catalyst layer 22 are also filled with the electrolytic solution 40. In the following description, the space between the negative electrode 3 and the positive electrode 2, when viewed along the central axis J1, is referred to as the “electrolyte layer 4.” That is, the electrolyte layer 4 is disposed between the negative electrode 3 and the positive electrode 2. In the present embodiment, the electrolyte layer 4 includes the separator 41.

The electrolyte solution 40 is an aqueous alkaline solution that preferably contains an aqueous potassium hydroxide (caustic potash, KOH) solution or an aqueous sodium hydroxide (caustic soda, NaOH) solution. The electrolyte solution 40 also contains zinc ions or ions containing zinc. That is, zinc ions contained in the electrolyte solution 40 may be in various forms and may be regarded as ions containing zinc (i.e., zinc atoms). For example, zinc ions may exist as tetrahydroxy zinc ions.

The opposite end surfaces of the negative electrode 3, the electrolyte layer 4, and the positive electrode 2 in the direction of the central axis J1 are fixed to disc-like closure members. Each closure member has a through hole in the center. In the metal-air battery 1, the liquid repellent layer 29 and the closure members prevent the electrolyte solution 40 inside the metal-air battery 1 from leaking out from portions other than the aforementioned through holes to the outside. The electrolyte solution may also be circulated between the main body 11 and a reservoir tank (not shown) by using the through holes of the closure members on the opposite end surfaces.

During discharge in the metal-air battery 1 in FIG. 1, the negative electrode current collecting terminal and the positive electrode current collecting terminal are electrically connected to each other via, for example, a load such as lighting equipment. Zinc contained in the negative electrode 3 is oxidized into zinc ions, and electrons therein are supplied to the negative electrode current collecting terminal and to the positive electrode 2 via the positive electrode current collecting terminal. In the porous positive electrode 2, oxygen from the air, which has passed through the liquid-repellent layer 29, is reduced by the electrons supplied from the negative electrode 3 and dissolved as hydroxide ions in the electrolyte solution. In the positive electrode 2, the positive electrode catalyst accelerates oxygen reduction reactions.

During charge in the metal-air battery 1, on the other hand, a voltage is applied between the negative electrode current collecting terminal and the positive electrode current collecting terminal, so that electrons are supplied from hydroxide ions to the positive electrode 2 and oxygen is generated. In the negative electrode 3, metal ions are reduced by the electrons supplied to the negative electrode current collecting terminal via the positive electrode current collecting terminal, and zinc is deposited.

At this time, electric field concentrations are less likely to occur because the coiled negative electrode 3 has no corners. That is, there occurs no large imbalance in current density. In addition, the negative electrode 3 is in uniform contact with the electrolyte solution 40. As a result, generation and growth of zinc dendrites deposited in dendritic form and zinc whiskers deposited in whisker form (needle-like form) are considerably suppressed. In actuality, close-grained zinc is uniformly deposited on almost the entire surface of the negative electrode 3, and a deposited metal layer is formed thereon. In the positive electrode 2, the positive electrode catalyst contained in the positive electrode catalyst layer 22 accelerates oxygen generation. Moreover, the positive electrode 2 does not suffer from oxidation degradation caused by the oxygen generated during charge, because no carbon material is used for the positive electrode 2.

Next, the details of the positive electrode catalyst layer 22 will be described. In the positive electrode catalyst layer 22, particles of two types of perovskite-type oxides (e.g., LSM, LSCF, or LSMF) that have electrical conductivity are dispersed as the positive electrode catalyst. One of the perovskite-type oxides has an average particle diameter greater than or equal to 2 μm and less than or equal to 9 μm. The other perovskite-type oxide has an average particle diameter greater than or equal to 0.10 μm and less than or equal to 1.0 μm. In this way, the average particle diameter of one of the perovskite-type oxides is greater than the average particle diameter of the other perovskite-type oxide. Out of the two types of perovskite-type oxides, the perovskite-type oxide with a larger average particle diameter is referred to as a “first perovskite-type oxide” and the perovskite-type oxide with a smaller average particle diameter is referred to as a “second perovskite-type oxide” in the following description. A standard deviation in particle diameter (diameter) of each of the first and second perovskite-type oxides is preferably less than or equal to the average particle diameter of the perovskite-type oxide, and more preferably less than or equal to a half of the average particle diameter.

FIG. 2 illustrates a photograph of the positive electrode catalyst layer 22 taken with an electron microscope. In FIG. 2, particles of the first perovskite-type oxide are indicated by reference numeral 221, and particles of the second perovskite-type oxide are indicated by reference numeral 222. The positive electrode catalyst layer 22 is formed by firing a mixture of particles of the first perovskite-type oxide and particles of the second perovskite-type oxide at a relatively high temperature (e.g., 1000° C.). As illustrated in FIG. 2, a framework structure of the positive electrode catalyst layer 22 is formed by bonding the particles of the first perovskite-type oxide, which are coarse particles. This structure allows the positive electrode catalyst layer 22 to maintain a certain level of mechanical strength.

Moreover, the particles of the second perovskite-type oxide, which are fine particles, are bonded to the surfaces of the particles of the first perovskite-type oxide. At this time, if one of the perovskite-type oxides is simply supported by the particles of the other perovskite-type oxide, the bonding between the perovskite-type oxides will become insufficient. However, a large number of joints (necking portions) exists in the positive electrode catalyst layer 22, in which the particles of the first and second perovskite-type oxides are bonded together by firing. At these necking portions, i.e., interfaces between different types of materials (heterointerfaces), high catalytic activity is obtained. Accordingly, the metal-air battery 1 including the positive electrode catalyst layer 22 can have improved battery performance.

If the average particle diameter of the first perovskite-type oxide contained in the positive electrode catalyst layer 22 is greater than 9 μm, it is necessary to set the firing temperature to a high value in order to implement the formation of the framework structure of the first perovskite-type oxide in the positive electrode catalyst layer 22. In this case, the sintering of the particles of the second perovskite-type oxide progresses excessively; the surface area of the second perovskite-type oxide decreases due to difficulty in maintaining the shape of the particles; and battery performance decreases. If the average particle diameter of the first perovskite-type oxide is less than 2 μm, it becomes difficult to form the aforementioned framework structure, and adhesive strength between the positive electrode catalyst layer 22 and the adjacent layer decreases. If the average particle diameter of the second perovskite-type oxide is greater than 1.0 μm, the area of heterointerfaces is not enough, and the improvement of battery performance is insufficient. If the average particle diameter of the second perovskite-type oxide is less than 0.10 μm, it is difficult to maintain the shape of particles during the firing of the positive electrode catalyst layer 22, and battery performance decreases.

The volume of the first perovskite-type oxide contained in the positive electrode catalyst layer 22 is preferably 0.25 times or more the volume of the second perovskite-type oxide. This ensures a sufficient volume of the first perovskite-type oxide and more reliably maintains the strength of the positive electrode catalyst layer 22. The volume of the first perovskite-type oxide is also preferably four times or less the volume of the second perovskite-type oxide. This ensures a large number of necking portions in the positive electrode catalyst layer 22 and more reliably improves battery performance.

In a preferable example of the metal-air battery 1, one of the first and second perovskite-type oxides is LSMF, and the other perovskite-type oxide is LSCF. The use of LSMF superior in oxygen reduction reaction to LSCF improves the discharge performance of the metal-air battery 1. Also, the use of LSCF superior in oxygen generation reaction to LSMF improves the charge performance of the metal-air battery 1. The positive electrode catalyst layer 22 may use other perovskite-type oxides. The metal-air battery 1 with excellent discharge and charge reactions can be achieved if one of the first and second perovskite-type oxides is superior in oxygen reduction reaction and the other perovskite-type oxide is superior in oxygen generation reaction. Preferably, the positive electrode catalyst layer 22 is composed of only two types of perovskite-type oxides. Depending on the design of the metal-air battery 1, the positive electrode catalyst layer 22 may contain other materials.

In the metal-air battery 1, the positive electrode 2 and the separator 41 are prepared as an integral member. In the preparation of the positive electrode 2, first, a tubular compact is formed by extrusion molding of a mixture that contains, for example, conductive ceramic powder, an organic binder, and an organic solvent. For example, a perovskite-type oxide is used as the conductive ceramic. The compact is then subjected to firing so as to form the tubular positive electrode conductive layer 21 as a porous support.

Before the firing, the compact may be subjected to heat treatment at a temperature of 100 to 800° C. to decompose and remove organic components in the compact (the same applies to the formation of other layers involving firing). The firing is preferably conducted at a temperature of 900 to 1500° C. with any condition as long as the compact is sintered adequately and capable of securing good battery performance, gas permeability and electrolyte permeability. Alternatively, the compact may be co-fired with other layers described below. The co-firing helps improve the adhesive strength between the compact and the other layers. The co-firing also helps reduce lead times in the firing step, as compared with the case where each layer is fired individually. The positive electrode conductive layer 21 may be formed by techniques other than extrusion molding and firing.

When the positive electrode conductive layer 21 has been prepared, slurry that contains, for example, a positive electrode catalyst, an organic binder, and an organic solvent is deposited on the outer side surface of the positive electrode conductive layer 21 by a slurry coating method, and then fired to form the positive electrode catalyst layer 22. As described previously, different types of perovskite oxides, namely the first perovskite-type oxide and the second perovskite-type oxide, are used as the positive electrode catalyst. For example, one of the first and second perovskite-type oxides is LSMF, and the other perovskite-type oxide is LSCF. The formation (deposition) of the slurry film may use various techniques such as casting, dipping, spraying, and printing. The film thickness of each layer of the positive electrode 2 is properly adjusted in consideration of firing shrinkage during firing and from the viewpoint of securing properties relating to battery performance such as gas permeability and electrolyte permeability.

The firing of the slurry involved in the formation of the positive electrode catalyst layer 22 is conducted at a temperature of, for example, 900 to 1500° C., and preferably conducted at a temperature around 1000° C. If the firing is conducted at an excessively low temperature, the necking between the particles of the two types of perovskite-type oxides is insufficient; the area of heterointerfaces is not enough; and battery performance decreases. On the other hand, if the firing is conducted at an excessively high temperature, it is difficult to maintain the shape of the particles of the second perovskite-type oxide with a small average particle diameter; the surface area of the second perovskite-type oxide decreases; and catalyst performance decreases. The firing temperature may be arbitrarily determined depending on factors such as the composition ratio and average particle diameters of the first and second perovskite-type oxides. The positive electrode catalyst layer 22 may be formed by techniques other than the aforementioned deposition and firing (the same applies to the interconnector 24, the separator 41, and the liquid-repellent layer 29).

When the positive electrode catalyst layer 22 has been formed, the outer side surface of the positive electrode catalyst layer 22 is masked except for a given area. Then, a film is formed on that area by a slurry coating method using slurry that contains fine powder such as a perovskite-type oxide, and the film is fired to form the interconnector 24. Note that the positive electrode catalyst layer 22 and the interconnector 24 may be formed by co-firing (the same applies to the other layers formed by firing).

When the interconnector 24 has been formed, slurry that contains a separator forming material is deposited on the inner side surface of the positive electrode conductive layer 21 by a slurry coating method, and then the slurry is fired to form the separator 41. As the separator forming material, ceramic having insulating properties is used, for example. From the viewpoint of reducing the manufacturing cost of the metal-air battery 1, it is preferable to use alumina as the separator forming material. From the viewpoint of ensuring the strength of the separator 41 and stability, it is preferable to use zirconia as the separator forming material.

In the case where the separator 41 is made of a material such as alumina or zirconia and the positive electrode conductive layer 21 is made of LSC (LaSrCoO₃) or LSCF, a reaction phase may be formed between the separator 41 and the positive electrode conductive layer 21, causing problems such as a reduction in the electrical conductivity of the positive electrode conductive layer 21 and clogging of the pores. In this case, it is preferable that an anti-reaction layer that contains, for example, ceria be formed between the separator 41 and the positive electrode conductive layer 21. Meanwhile, if there is a large difference in the coefficient of linear expansion between the separator 41 and the positive electrode conductive layer 21, cracking may occur during firing. In this case, it is preferable that a layer for lessening the difference in the coefficient of linear expansion be formed between the separator 41 and the positive electrode conductive layer 21.

When the positive electrode catalyst layer 22, the interconnector 24, and the separator 41 have been formed on the positive electrode conductive layer 21, slurry that contains a liquid repellent material is applied to the outer side surface of the positive electrode catalyst layer 22 and then fired so that a portion in the vicinity of the outer side surface of the positive electrode catalyst layer 22 becomes the liquid repellent layer 29. In the application of the slurry containing a liquid repellent material, it is preferable that the area corresponding to the interconnector 24 be masked. As the liquid repellent material, FEP or PTFE is used, for example. The depth of impregnation of the slurry in the depth direction of the positive electrode catalyst layer 22 is adjusted by adding a necessary amount of a thickener to the slurry so as to adjust the viscosity of the slurry. This adjustment allows three-phase interfaces to be formed in the positive electrode catalyst layer 22 while preventing surfaces of the particles in the pores of the positive electrode catalyst layer 22 from being completely covered with the liquid repellent material. Through the processing described above, the positive electrode 2 including the separator 41 is prepared.

As described above, particles of different types of perovskite-type oxides, namely the first perovskite-type oxide and the second perovskite-type oxide, are dispersed in the positive electrode catalyst layer 22 of the positive electrode 2. Since the average particle diameter of the first perovskite-type oxide is greater than or equal to 2 μm and less than or equal to 9 μm, the framework structure of the positive electrode catalyst layer 22 is firmly formed by the particles of the first perovskite-type oxide, which is a catalyst with large particle diameters. This allows the positive electrode catalyst layer 22 to ensure a certain level of strength. Moreover, the average particle diameter of the second perovskite-type oxide, which is a catalyst with small particle diameters, is greater than or equal to 0.10 μm and less than or equal to 1.0 μm. This increases the total area of heterointerfaces at which high catalytic activity is obtained, and improves the battery performance of the metal-air battery 1.

While the positive electrode conductive layer 21 serves as a support in the metal-air battery 1 in FIG. 1, other constituent elements may serve as a support. An example where the separator 41 serves as a support will now be described. The separator 41 serving as a support is a porous sintered compact of ceramic. Examples of the ceramic include alumina and zirconia. The positive electrode 2 is formed on the outer side surface of the separator 41 that is part of the electrolyte layer 4. More specifically, the positive electrode conductive layer 21 is formed on the outer side surface of the separator 41, and the positive electrode catalyst layer 22 is formed on the outer side surface of the positive electrode conductive layer 21. The positive electrode conductive layer 21 is formed by, for example, depositing predetermined slurry that contains, for example, a perovskite-type oxide, an organic binder, and an organic solvent on the outer side surface of the separator 41 and firing the slurry. Examples of the deposition technique include doctor blading, rolling, and pressing. The positive electrode catalyst layer 22, the interconnector 24, and the liquid-repellent layer 29 are identical to those in the metal-air battery 1 in FIG. 1.

With the metal-air battery 1 using the separator 41 as a support, the electrical conductivity of the positive electrode 2 as a whole can be increased and a certain level of battery performance can be ensured if the positive electrode conductive layer 21 is formed to a somewhat large thickness. The positive electrode catalyst layer 22 can ensure a certain level of strength if the average particle diameter of the first perovskite-type oxide, which is a catalyst with large particle diameters, is greater than or equal to 2 μm and less than or equal to 9 μm. Moreover, the battery performance of the metal-air battery 1 can be improved if the average particle diameter of the second perovskite-type oxide, which is a catalyst with small particle diameters, is greater than or equal to 0.10 μm and less than or equal to 1.0 μm.

Next is a description of charge and discharge performance and peel strength when the average particle diameters and volume ratios of the first and second perovskite-type oxides in the positive electrode catalyst layer 22 have been changed. Here, samples were prepared for evaluation of the positive electrode 2 using the positive electrode conductive layer 21 as a support.

In the preparation of the evaluation samples, first, LaSrMnO₃ (LSM) powder (produced by KCM Corporation Co., Ltd.) was pulverized into coarse particles by a cutter mill and then into small particles by a jet mill (manufactured by Nissin Engineering INC.), and then classified by Turbo Classifier (manufactured by Nissin Engineering INC.) to obtain LSM powder with an average particle diameter of 30 μm. Part of the powder was pulverized into fine particles by a ZrO₂ ball to obtain LSM powder with an average particle diameter of 0.5 μm. Then, 100 parts by mass of the powder with an average particle diameter of 30 μm, 5 parts by mass of the powder with an average particle diameter of 0.5 μm, 12 parts by mass of ion-exchanged water, 12 parts by mass of a binder (produced by YUKEN Industry Co., Ltd.), and 4 parts by mass of glycerin were weighed and combined into a mixture, and the mixture was subjected to extrusion molding to mold a cylindrical tube with an outer diameter (diameter) of 17.0 mm and an inner diameter of 12.8 mm. This cylindrical tube was fired at 1450° C. for five hours in the ambient atmosphere and then cut to a length of 70 mm. In this way, a cylindrical porous tube was obtained, which served as a conductive layer (positive electrode conductive layer 21) and also served as a support.

Next, 75 parts by mass of SOLMIX (registered trademark) H-37 (produced by Japan Alcohol Trading Co. Ltd.), 25 parts by mass of 2-(2-n-Butoxyethoxy)ethyl acetate (produced by Kanto Chemical Co., Inc.), and 3.4 parts by mass of ethyl cellulose (produced by Tokyo Chemical Industry Co., Ltd.) were weighed and combined, and stirred for one hour. Then, 32 parts by mass of alumina (e.g., A-43-M produced by SHOWA DENKO K.K.) was weighed, put in a pot mill with a resin ball having a diameter of 10 mm and the stirred mixture, and combined for 50 hours using a ball mill. In this way, slurry for separators was obtained.

A hose-like cap (which played a role of a funnel) was placed in the upper opening of the aforementioned porous tube, and a sealing stopper was placed in the lower opening. The hose-like cap in the upper opening was used to prevent an overflow of slurry. By using the funnel, the slurry for separators was injected from the upper opening into the porous tube covered with the hose-like cap. The porous tube filled up with the slurry was held for one minute. Thereafter, the sealing stopper in the lower opening was removed to discharge the slurry. The porous tube was dried at ambient temperature for 15 hours or more and then dried at 50° C. for two hours or more. The porous tube was then placed upside down, and the above-described operations were repeated once again. Thereafter, the porous tube was fired at 1150° C. for four hours to form a separator on the inner side surface of the porous tube.

Then, LaSrMnFeO₃ (LSMF) powder and LaSrCoFeO₃ (LSCF) powder (produced by KCM Corporation Co., Ltd.) were pulverized into coarse particles by a cutter mill and then into fine particles by a jet mill, and classified by Turbo Classifier to obtain LSMF powder and LSCF powder with a plurality of combinations of average particle diameters. Meanwhile, 75 parts by mass of SOLMIX H-37, 25 parts by mass of 2-(2-n-butoxyethoxy)ethyl acetate, and 5 parts by mass of ethyl cellulose were weighed and combined, and stirred for one hour. Then, 65 parts by mass of mixed powder obtained by mixing the LSMF powder and the LSCF powder was weighed, put in a pot mill with a resin ball having a diameter of 10 mm and the stirred mixture, and combined for 50 hours using a ball mill. In this way, slurry for catalyst layers was obtained. At this time, the volume ratio and average particle diameters of the LSMF powder and the LSCF powder in the mixed powder were changed to a plurality of different patterns so as to obtain a plurality of types of slurry for catalyst layers.

Each type of slurry for catalyst layers was injected into a graduated cylinder, and the porous tube was inserted (dipped) into the graduated cylinder and held for one minute while the upper and lower openings of the porous tube were sealed with silicone rubber. The porous tube was then air-dried for 30 minutes and dried at 80° C. for one and a half hours. Thereafter, the porous tube was fired at 1150° C. for five hours in the ambient atmosphere. In this way, a catalyst layer was formed on the outer side surface of the porous tube.

Then, 75 parts by mass of SOLMIX H-37, 25 parts by mass of 2-(2-n-butoxyethoxy)ethyl acetate, and 5 parts by mass of ethyl cellulose were weighed and combined, and stirred for one hour. Then, 40 parts by mass of the LSCF powder with an average particle diameter of 0.4 μm was weighed, put in a pot mill with a resin ball having a diameter of 10 mm and the stirred mixture, and combined for 50 hours using a ball mill. In this way, slurry for interconnectors was obtained.

The outer side surface of the above porous tube was masked except for areas for interconnects (two areas set at an interval of 180 degrees in the circumferential direction). The slurry for interconnectors was injected into a graduated cylinder, and the porous tube was inserted (dipped) into the graduated cylinder and held for one minute while the upper and lower openings of the porous tube were sealed with silicone rubber. Then, the porous tube was air-dried for 30 minutes and dried at 80° C. for one and a half hours, which were repeated five times. Thereafter, the porous tube was fired at 1150° C. for four hours in the ambient atmosphere. In this way, interconnectors were formed on the porous tube.

Undiluted FEP dispersion (produced by Du Pont-Mitsui Fluorochemicals Co., Ltd.) was diluted to 20 parts by mass, and 2.5 parts by mass of ALKOX (registered trademark) E-30 (produced by MEISEI Corporation), which served as a thickener, was weighed and added by small amounts to the diluted FEP solution while stirring the solution in order not to form a cluster of the thickener.

The interconnector portions of the porous tube were covered with a tape so that portions of the liquid-repellent layer that were to overlap with the interconnectors had a width of 1 mm, and the porous tube was immersed in the aforementioned dispersion for one minute. Then, the porous tube was dried at ambient temperature for 30 minutes, dried at 60° C. for 15 hours, and further fired at 280° C. for 50 minutes in the ambient atmosphere. In this way, the liquid repellent layer was formed in the portion of the porous tube in the vicinity of the outer side surface of the catalyst layer.

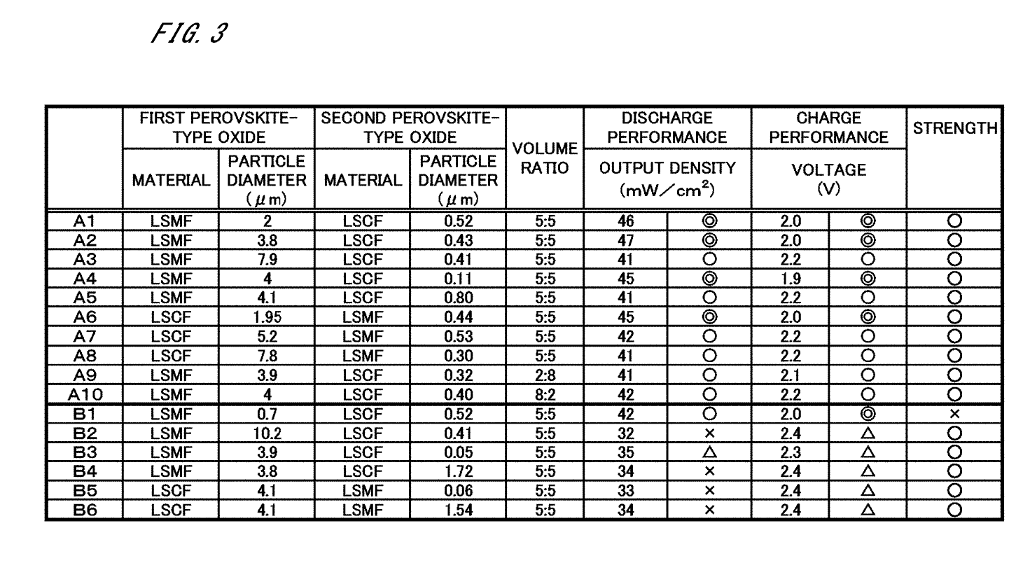

As described previously, Samples A1 to A10 and Samples B1 to B6 were prepared by using a plurality of types of slurry for catalysts, in which LSMF powder and LSCF powder had different volume ratios and different average particle diameters. FIG. 3 shows the material for and average particle diameter of the first perovskite-type oxide (catalyst with large particle diameters), the material for and average particle diameter of the second perovskite-type oxide (catalyst with small particle diameters), and the volume ratio between the first and second perovskite-type oxides (the volume of the first perovskite-type oxide:the volume of the second perovskite-type oxide). Here, each sample was ruptured to take a photograph of a cross-section with a scanning electron microscope; and for each of the first and second perovskite-type oxides, particle diameters of 50 particles were calculated by an intercept method and an average value of these particle diameters was calculated as an average particle diameter. Only in the preparation of Sample B2, the firing temperature during formation of a catalyst layer was set to 1250° C.

FIG. 3 also shows the results of evaluating battery performance and the results of evaluating the strength of the catalyst layer for Samples A1 to A10 and Samples B1 to B6. In the evaluation of the battery performance, a Cu coil (negative electrode) having 2 grams of zinc electrodeposited thereon was inserted inside each sample, and an electrolyte solution (which contained 7 molar (M) KOH and 0.65 M zinc oxide (ZnO)) was circulated inside the sample, so as to measure the charge and discharge performance of the battery at ambient temperature. As for the discharge performance, an output density greater than or equal to 45 mW/cm² was marked with a double circle; an output density greater than or equal to 40 mW/cm² and less than 45 mW/cm² was marked with a single circle; an output density greater than or equal to 35 mW/cm² and less than 40 mW/cm² was marked with a triangle; and an output density less than 35 mW/cm² was marked with a letter X. As for the charge performance, a charge voltage less than or equal to 2.0V was marked with a double circle; a charge voltage greater than 2.0V and less than or equal to 2.2V was marked with a single circle; a charge voltage greater than 2.2V and less than or equal to 2.4V was marked with a triangle; and a charge voltage greater than 2.4V was marked with a letter X. In the evaluation of the strength of the catalyst layer, a tape peeling test was conducted in which a 20×15 mm cellophane tape was attached to and peeled off from the surface of the catalyst layer. Samples with no delamination of the catalyst layer and the conductive layer were marked with a single circle, and samples with delamination were marked with a letter X.

In Sample B1 in which the first perovskite-type oxide as a catalyst with large particle diameters had a small average particle diameter of 0.7 μm, the strength of the catalyst layer decreased because the framework structure was not adequately formed of the first perovskite-type oxide. In sample B2 in which the first perovskite-type oxide had an excessively large average particle diameter of 10.2 μm, a need arose to set the firing temperature to a high value in order to form the framework structure of the first perovskite-type oxide. This caused the sintering of the particles of the second perovskite-type oxide, which was a catalyst with small particle diameters, to progress excessively, making it difficult to maintain the shapes of these parties and degrading battery performance. In samples B3 and B5 in which the second perovskite-type oxides respectively had excessively small average particle diameters of 0.05 μm and 0.06 μm, the sintering of the particles of the second perovskite-type oxides progressed excessively, making it difficult to maintain the shapes of the particles and degrading battery performance. In samples B4 and B6 in which the second perovskite-type oxides respectively had large average particle diameters of 1.7 μm and 1.5 μm, heterointerfaces were not formed adequately, and battery performance decreased.

In contrast, Samples A1 to A10 obtained satisfactory results of both the battery performance and the strength of the catalyst layer. From this, it becomes clear that it is possible to improve battery performance while maintaining a certain level of strength of the catalyst layer if the first perovskite-type oxide has an average particle diameter greater than or equal to 2 μm and less than or equal to 8 μm, and the second perovskite-type oxide has an average particle diameter greater than or equal to 0.10 μm and less than or equal to 0.8 μm.

In actuality, Samples A3 and A8 in which the first perovskite-type oxides had average particle diameters of approximately 8 μm exhibited sufficiently higher battery performance than Sample B2 in which the first perovskite-type oxide had an average particle diameter of approximately 10 μm. From this, it can be said that the battery performance can be improved if the average particle diameter of the first perovskite-type oxide is less than or equal to 9 μm. Moreover, Sample A5 in which the second perovskite-type oxide had an average particle diameter of approximately 0.80 μm exhibited sufficiently higher battery performance than Samples B4 and B6 in which the second perovskite-type oxides respectively had average particle diameters of 1.72 μm and 1.54 μm. From this, it can be said that the battery performance can be improved if the average particle diameter of the second perovskite-type oxide is less than or equal to 1.0 μm.

The results of the battery performance of Samples A9, A2, and A10, which were closely analogous to one another in the average particle diameters of the first and second perovskite-type oxides, clearly show that a certain level of charge and discharge performance can be ensured in any of the cases where the volume ratio is one of 2:8, 5:5, and 8:2. Accordingly, the battery performance can more reliably be improved if the volume of the first perovskite-type oxide contained in the catalyst layer is 0.25 times (which corresponds to the volume ratio of 2:8) or more and 4 times (which corresponds to the volume ratio of 8:2) or less the volume of the second perovskite-type oxide.

From the results of the battery performance of Samples A1, A2, A4, and A6, it can be said that it is preferable, in order to further improve the battery performance, that the volume of the first perovskite-type oxide contained in the catalyst layer is approximately equal to the volume of the second perovskite-type oxide; the first perovskite-type oxide has an a average particle diameter less than or equal to 4 μm; and the second perovskite-type oxide has an average particle diameter less than or equal to 0.5 μm. For example, the volumes of the first and second perovskite-type oxides can be regarded as approximately equal when the volume ratio is in the range of 4:6 to 6:4.

The metal-air battery 1 described above may be modified in various ways.

While the positive electrode 2 and the electrolyte layer 4 each are disposed in a tubular shape about the negative electrode 3 in the above-described embodiment, the metal-air battery 1 may be configured such that the negative electrode 3 is disposed around a tubular positive electrode 2. As another alternative, the positive electrode 2 and the negative electrode 3 may have a plate-like shape. The metal-air battery 1 does not necessarily have to circulate the electrolytic solution. For example, if the generation of dendrites presents no problems, the separator 41 may be omitted.

The electrode including the above-described positive electrode catalyst layer 22 may be used as positive electrodes in metal-air secondary batteries other than zinc-air secondary batteries.

The configurations of the above-described preferred embodiments and variations may be appropriately combined as long as there are no mutual inconsistencies.

While the invention has been shown and described in detail, the foregoing description is in all aspects illustrative and not restrictive. It is therefore to be understood that numerous modifications and variations can be devised without departing from the scope of the invention.

### REFERENCE SIGNS LIST

1 Metal-air battery
2 Positive electrode
3 Negative electrode
4 Electrolyte layer
21 Positive electrode conductive layer
22 Positive electrode catalyst layer

1. An electrode for use in a metal-air secondary battery, comprising:
a conductive layer having electrical conductivity; and
a catalyst layer laminated on said conductive layer,
wherein particles of a first perovskite-type oxide and particles of a second perovskite-type oxide are dispersed in said catalyst layer, said first perovskite-type oxide and said second perovskite-type oxide being of different types,
said first perovskite-type oxide has an average particle diameter greater than or equal to 2 micrometers and less than or equal to 9 micrometers, and
said second perovskite-type oxide has an average particle diameter greater than or equal to 0.10 micrometers and less than or equal to 1.0 micrometers.

2. The electrode according to claim 1, wherein
a volume of said first perovskite-type oxide contained in said catalyst layer is 0.25 times or more and 4 times or less a volume of said second perovskite-type oxide.

3. The electrode according to claim 2, wherein
the volume of said first perovskite-type oxide contained in said catalyst layer is approximately equal to the volume of said second perovskite-type oxide,
said first perovskite-type oxide has an average particle diameter less than or equal to 4 micrometers, and
said second perovskite-type oxide has an average particle diameter less than or equal to 0.5 micrometers.

4. The electrode according to claim 1, wherein
one of said first perovskite-type oxide and said second perovskite-type oxide is LaSrMnFeO₃, and the other of said first perovskite-type oxide and said second perovskite-type oxide is LaSrCoFeO₃.

5. A metal-air secondary battery comprising:
a positive electrode that is the electrode according claim 1;
a negative electrode; and
an electrolyte layer disposed between said negative electrode and said positive electrode.

6. The metal-air secondary battery according to claim 5, wherein
said positive electrode and said electrolyte layer each are disposed in a tubular shape about said negative electrode.

7. The electrode according to claim 2, wherein
one of said first perovskite-type oxide and said second perovskite-type oxide is LaSrMnFeO₃, and the other of said first perovskite-type oxide and said second perovskite-type oxide is LaSrCoFeO₃.

8. The electrode according to claim 3, wherein
one of said first perovskite-type oxide and said second perovskite-type oxide is LaSrMnFeO₃, and the other of said first perovskite-type oxide and said second perovskite-type oxide is LaSrCoFeO₃.

9. A metal-air secondary battery comprising:
a positive electrode that is the electrode according to claim 2;
a negative electrode; and
an electrolyte layer disposed between said negative electrode and said positive electrode.

10. The metal-air secondary battery according to claim 9, wherein
said positive electrode and said electrolyte layer each are disposed in a tubular shape about said negative electrode.

11. A metal-air secondary battery comprising:
a positive electrode that is the electrode according to claim 3;
a negative electrode; and
an electrolyte layer disposed between said negative electrode and said positive electrode.

12. The metal-air secondary battery according to claim 11, wherein
said positive electrode and said electrolyte layer each are disposed in a tubular shape about said negative electrode.

13. A metal-air secondary battery comprising:
a positive electrode that is the electrode according to claim 4;
a negative electrode; and
an electrolyte layer disposed between said negative electrode and said positive electrode.

14. The metal-air secondary battery according to claim 13, wherein
said positive electrode and said electrolyte layer each are disposed in a tubular shape about said negative electrode.
